(19) United States
(12) Patent Application Publication
(10) Pub. No.: US 2005/0056089 A1
(43) Pub. Date: Mar. 17, 2005

(54) Air transfer apparatus and control method of air transfer apparatus

(75) Inventors: Hironori Ohhashi, Atsugi-shi (JP); Hajime Hosoya, Atsugi-shi (JP)

Correspondence Address: FOLEY AND LARDNER;SUITE 500, 3000 K STREET NW, WASHINGTON, DC, 20007, US

(73) Assignee: HITACHI UNISIA AUTOMOTIVE, LTD.

(21) Appl. No.: 10/932,046

(22) Filed: Sep. 2, 2004

(30) Foreign Application Priority Data
Sep. 10, 2003 (JP) 2003-317993

(51) Int. Cl. G01M 19/00

(52) U.S. Cl. 73/118.1

(57) ABSTRACT

In an air transfer apparatus comprising an air pump supplying air to a shielded section and a valve disposed in a transfer passage through which the air is transferred by the air pump, for pressurizing the shielded section, the valve is controlled to open with a delay to the operation start of the air pump, and also controls the valve to close before the operation stop of the air pump.

### FIELD OF THE INVENTION

The present invention relates to an air transfer apparatus for supplying air to a shielded section by an air pump or sucking air from the shielded section by the air pump, and a control apparatus of the air transfer apparatus.

### RELATED ART

Japanese Unexamined Patent Publication No. 2003-013810 discloses a diagnosis apparatus for diagnosing whether or not the leakage occurs in a fuel vapor passage of a fuel vapor purge system.

In this diagnosis apparatus, the fuel vapor passage is shielded by means of a valve, and the shielded section is supplied with air by an air pump, to be pressurized.

Then, based on a driving load of the air pump, it is judged whether or not the leakage occurred in the fuel vapor passage.

In the above diagnosis apparatus, a check valve is disposed in a supply passage through which air is supplied by the air pump, to prevent the backflow.

However, in the case of using a mechanical check valve, since the backflow cannot be reliably prevented, sometimes, the backflow occurs. Then, due to the occurrence of backflow, the accuracy of leakage diagnosis is lowered. Further, the fuel vapor reaches the air pump, resulting in the deterioration of the air pump.

### SUMMARY OF THE INVENTION

The present invention has an object to prevent an occurrence of backflow in a transfer passage through which air is transferred by an air pump.

In order to achieve the above object, according to the present invention, there is provided an air transfer apparatus comprising: an air pump, which transfers air to a shielded section; and a valve disposed in a transfer passage through which the air is transferred by the air pump, wherein a time lag is set between switching control timing of operation/stop of the air pump, and open/close control timing of the valve.

The other objects and features of this invention will become understood from the following description with reference to the accompanying drawings.

### BRIEF EXPLANATION OF THE DRAWINGS

FIG. 1 is a diagram showing a system configuration of an internal combustion engine in an embodiment.

FIG. 2 is a cross section of an electromagnetic check valve in the embodiment.

FIG. 3 is a flowchart showing a leakage diagnosis process in the embodiment.

FIG. 4 is a diagram showing a system configuration of the internal combustion engine added with a pressure sensor.

FIG. 5 is a diagram showing a system configuration of the internal combustion engine added with a differential pressure sensor.

FIG. 6 is a flowchart showing an embodiment in which valve opening timing of the electromagnetic check valve is delayed based on a pressure state.

FIG. 7 is a diagram showing a system configuration of the internal combustion engine provided with a mechanical check valve and an electromagnetic open/close valve.

### DESCRIPTION OF EMBODIMENTS

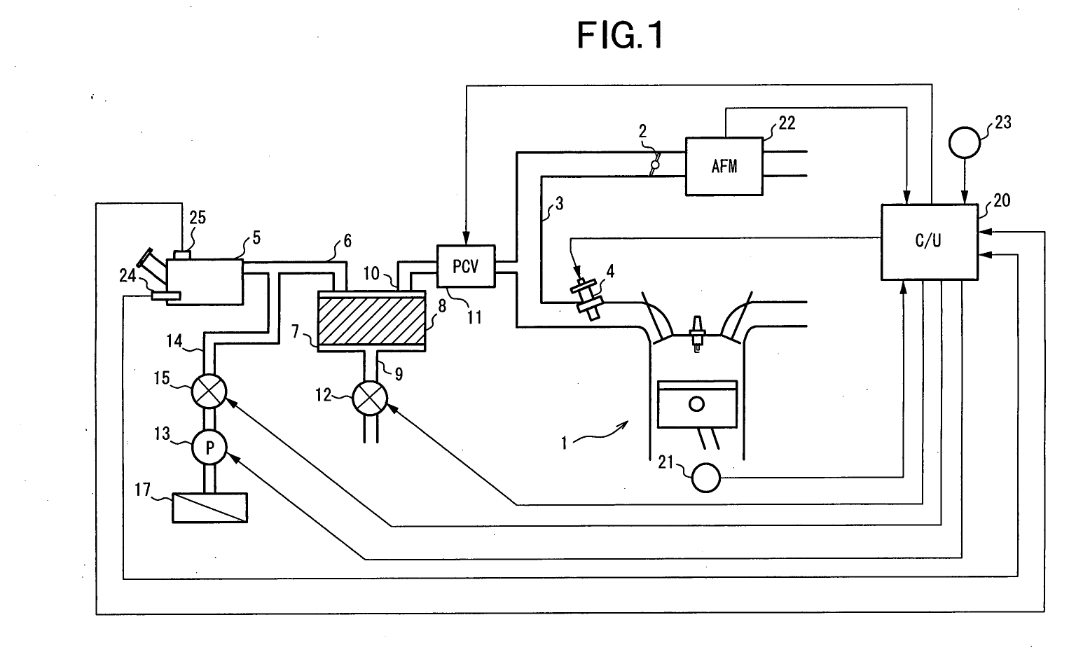

An internal combustion engine 1 shown In FIG. 1 is a gasoline engine installed in a vehicle.

A throttle valve 2 is disposed in an intake pipe 3 of internal combustion engine 1.

An intake air amount of internal combustion engine 1 is controlled by throttle valve 2.

For each cylinder, an electromagnetic type fuel injection valve 4 is disposed in a manifold portion of intake pipe 3 on the downstream side of throttle valve 2.

Fuel injection valve 4 injects fuel based on an injection pulse signal output from a control unit 20 incorporating therein a microcomputer.

Internal combustion engine 1 is provided with a fuel vapor purge system.

Fuel vapor purge system comprises an evaporation passage 6, a canister 7, a purge passage 10 and a purge control valve 11.

Fuel vapor generated in a fuel tank 5 is trapped to canister 7 via evaporation passage 6.

Canister 7 is a container filled with the adsorbent 8 such as activated carbon.

Further, a new air inlet 9 is formed to canister 7, and a purge passage 10 is connected to canister 7.

Purge passage 10 is connected to intake pipe 3 on the downstream side of throttle valve 2 via purge control valve 11.

Purge control valve 11 is opened based on a purge control signal output from control unit 20.

When a predetermined purge permission condition is established during an operation of internal combustion engine 1, purge control valve 11 is controlled to open.

When purge control valve 11 is controlled to open, an intake negative pressure of internal combustion engine 1 acts on canister 7, so that the fuel vapor adsorbed to canister 7 is detached by the fresh air, which is introduced through new air inlet 9.

Purged gas inclusive of the fuel vapor detached from canister 7 passes through purge passage 10 to be sucked into intake pipe 3.

Control unit 20 incorporates therein a microcomputer comprising a CPU, a ROM, a RAM, an A/D converter and an input/output interface.

Control unit 20 receives detection signals from various sensors.

As the various sensors, there are provided a crank angle sensor 21 detecting a rotation angle of a crankshaft, an air flow meter 22 measuring an intake air amount of internal combustion engine 1, a vehicle speed sensor 23 detecting a vehicle speed, a pressure sensor 24 detecting a pressure in fuel tank 5, and a fuel level sensor 25 detecting a fuel level in fuel tank 5.

Further, a drain cut valve 12 for opening/closing new air inlet 9 and an air pump 13 for supplying air to evaporation passage 6 are disposed, for diagnosing whether or not the leakage occurred in a fuel vapor passage of the fuel vapor purge system.

A discharge port of air pump 13 is connected to evaporation passage 6 via an air supply pipe 14.

An electromagnetic check valve 15 is disposed in the halfway of air supply pipe 14.

Electromagnetic check valve 15 is provided with an electromagnetic solenoid as an actuator generating the valve opening energy.

Then, electromagnetic check valve 15 can be opened/closed by performing the ON/OFF control of the electromagnetic solenoid, irrespective of a primary side pressure of electromagnetic check valve 15.

Further, an air cleaner 17 is disposed on the inlet port side of air pump 13.

When a diagnosis condition is established, control unit 20 controls purge control valve 11 and drain cut valve 12 to close.

As a result, a fuel tank 5, evaporation passage 6, canister 7 and purge passage 10 on the downstream of purge control valve 11, are shielded as a diagnosis section.

Here, if air pump 13 is activated, the diagnosis section is pressurized.

Then, it is diagnosed an occurrence of leakage in the diagnosis section, based on a pressure change in fuel tank 5 at the time when the diagnosis section is pressurized by air pump 13.

Note, it is possible to diagnose the occurrence of leakage, based on the pressure drop after the diagnosis section is pressurized up to a predetermined pressure.

Further, it is possible to diagnose the occurrence of leakage, based on a driving load of air pump 13 at the time when the diagnosis section is pressurized.

Moreover, it is possible that the pressure in the diagnosis section is reduced by sucking the air from the diagnosis section by air pump 13, to diagnose the occurrence of leakage, based on the pressure in fuel tank 5 or the driving load of air pump 13 at the time.

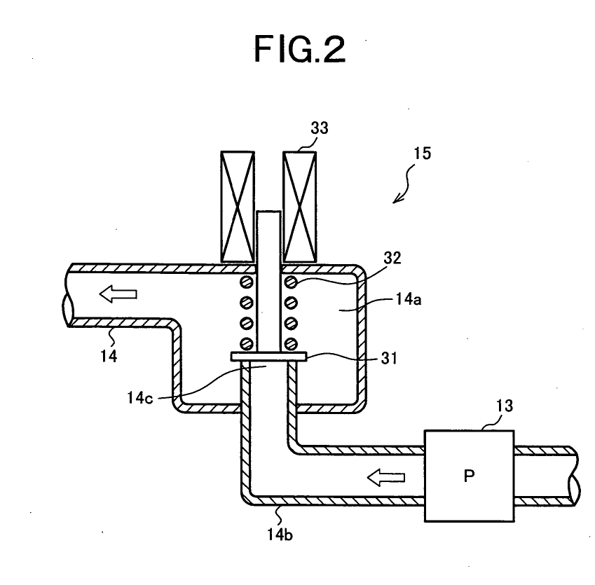

Electromagnetic check valve 15 is configured as shown in FIG. 2.

A volumetric chamber 14a, which is opened toward the downstream side, is formed in the halfway of air supply pipe 14.

Volumetric chamber 14a is connected to the discharge port of air pump 13 via air piping 14b.

An open end 14c of air piping 14b passes through a wall of volumetric chamber 14a, to be extended into volumetric chamber 14a.

A plate shaped valve 31 blocking open end 14c is urged by a coil spring 32 to a direction blocking open end 14c.

A fluid pressure in a backflow direction toward air pump 13 from evaporation passage 6, acts as a pressure to close valve 31, thereby preventing the backflow.

Further, electromagnetic check valve 15 is provided with an electromagnetic solenoid 33, which is supplied with the electric power to apply an electromagnetic force for valve opening on valve 31.

Here, a setting load of spring force of coil spring 32 is set to be a maximum generated pressure or above of air pump 13.

Accordingly, even if air pump 13 is driven at a maximum, in a state where electromagnetic solenoid 33 is OFF, electromagnetic check valve 15 is held in a closed state.

Therefore, when the diagnosis section is supplied with the air to be pressurized by air pump 13, electromagnetic solenoid 33 is turned ON, to generate the valve opening energy against an urging force for valve closing by coil spring 32.

As a result, it is possible to arbitrarily open/close electromagnetic check valve 15, by controlling the supply of electric current to electromagnetic solenoid 33.

Further, in the case where electromagnetic check valve 15 is disposed between evaporation passage 6 and air pump 13, the fuel vapor within evaporation passage 6 is prevented from reaching air pump 13.

Moreover, if the fuel vapor can be prevented from invading into air pump 13, by electromagnetic check valve 15, it becomes unnecessary to apply a complicated and expensive sealing structure.

Note, in the case where the diagnosis section is pressurized, electromagnetic check valve 15 can be disposed on an inlet side of air pump 13.

Further, in the case where the diagnosis section is depressurized, electromagnetic valve 15 can be disposed on a discharge side of air pump 13.

However, in order to reliably avoid that the fuel vapor from fuel vapor passage reaches air pump 13, in the case where the diagnosis section is pressurized, electromagnetic check valve 15 is disposed on the discharge side of air pump 13, while being disposed on the inlet side of air pump 13 in the case where the diagnosis section is depressurized.

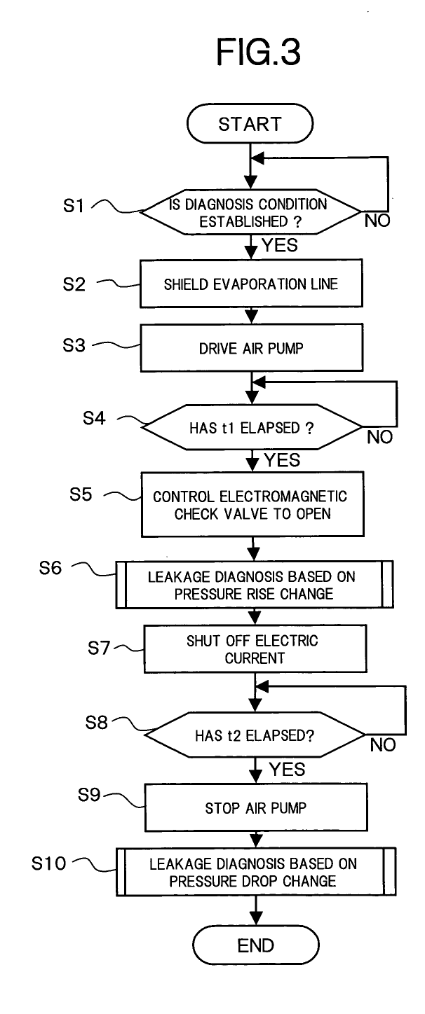

FIG. 3 is a flowchart showing the leakage diagnosis process.

In step S1, it is judged whether or not a leakage diagnosis execution condition is established.

If the leakage condition is established, control proceeds to step S2.

In step S2, in order to shield a section to be subjected to leakage diagnosis, purge control valve 11 and drain cut valve 12 are controlled to close.

In step S3, the pressurization by air pump 3 is started.

Subsequently, in step S4, it is judged whether or not a period of time t1 has elapsed after the operation start of air pump 13.

Then, control proceeds to step S5 after the period of time t1 has elapsed.

The period of time t1 is a time required for pressurizing the inside of air supply pipe 14 between air pump 13 and electromagnetic check valve 15, up to a fixed pressure or above.

Accordingly, at the time when the period of time t1 has elapsed after the operation start of air pump 13, a pressure on the upstream side of electromagnetic check valve 15 is sufficiently higher than that on the downstream side.

Therefore, if electromagnetic check valve 15 is opened at the time when the period of time t1 has elapsed after the operation start of air pump 13, it is possible to prevent the occurrence of backflow toward the air pump 13 side at the valve opening time.

By preventing the occurrence of backflow at the time of opening electromagnetic check valve 15, an initial pressure in a pressurization process can be accurately controlled, thereby enabling the improvement of the accuracy of leakage diagnosis.

Further, it is possible to prevent the fuel vapor from reaching a motor portion of air pump 13, thereby avoiding the corrosion of a circuit portion due to the fuel vapor.

Moreover, in the case where a mechanical check valve is used, it is possible to avoid the occurrence of backflow, by enlarging an urging force for valve closing by a spring. However, in this case, it is necessary to enhance the pressurization performance of air pump 13 in order to generate an opening pressure of check valve.

Furthermore, if the urging force for closing the mechanical check valve is large, a response delay of valve opening is large to cause a delay in a pressure rise change.

Contrary to the above, according to electromagnetic check valve 15 described above, since it is possible that the electric current supply to electromagnetic solenoid 33 is controlled to arbitrarily open or close electromagnetic check valve 15, electromagnetic check valve 15 can be opened by a minimum pressure at which the backflow does not occur.

Consequently, air pump 13 is not required to have the high pressurization performance, and also the pressurization can be performed with a good response characteristic.

In step S5, an electric current for valve opening is given to electromagnetic solenoid 33 of electromagnetic check valve 15.

As a result, electromagnetic check valve 15 is opened, so that the air pressurized by air pump 13 is supplied to the diagnosis section via electromagnetic check valve 15.

In step S6, based on a rise characteristic of the pressure in fuel tank 5, it is diagnosed whether or not the leakage occurred.

When the leakage diagnosis is finished, control proceeds to step S7.

In step S7, the supply of electric current to electromagnetic solenoid 33 is stopped, to close electromagnetic check valve 15.

In step S8, it is judged whether or not a period of time t2 has elapsed after the supply of electric current to electromagnetic solenoid 33 was stopped.

The period of time t2 is a time required until electromagnetic check valve is fully closed after the supply of electric current to electromagnetic solenoid 33 was stopped.

Note, in the case where a delay time in operation stop of air pump 13 is longer than a delay time in closing electromagnetic check valve 15, even if the process in step S8 is omitted, and the operation of air pump 13 is stopped immediately after the supply of electric current to electromagnetic solenoid 33 was stopped, it is possible to avoid the occurrence of backflow.

If it is judged in step S8 that the period of time t2 has elapsed after the supply of electric current to electromagnetic solenoid 33 was stopped, control proceeds to step S9, where the operation of air pump 13 is stopped.

As described above, if electromagnetic check valve 15 is closed prior to the operation stop of air pump 13, the occurrence of backflow is avoided when the operation of air pump 13 is stopped.

Consequently, it is possible that the pressure risen with the air supply can be confined within the diagnosis section just as it is, to improve the accuracy of leakage diagnosis based on a decrease change in the pressure confined within the diagnosis section.

Further, it is possible to prevent the fuel vapor from reaching the motor portion of air pump 13 when the operation of air pump 13 is stopped, thereby avoiding the corrosion of a circuit portion due to the fuel vapor.

In the above embodiment, electromagnetic check valve 33 is opened after the period of time t1 has elapsed after the operation start of air pump 13. However, it is possible to determine the valve opening timing of electromagnetic check valve 15 based on a pressure state of the downstream of air pump 13 after air pump 13 starts to operate.

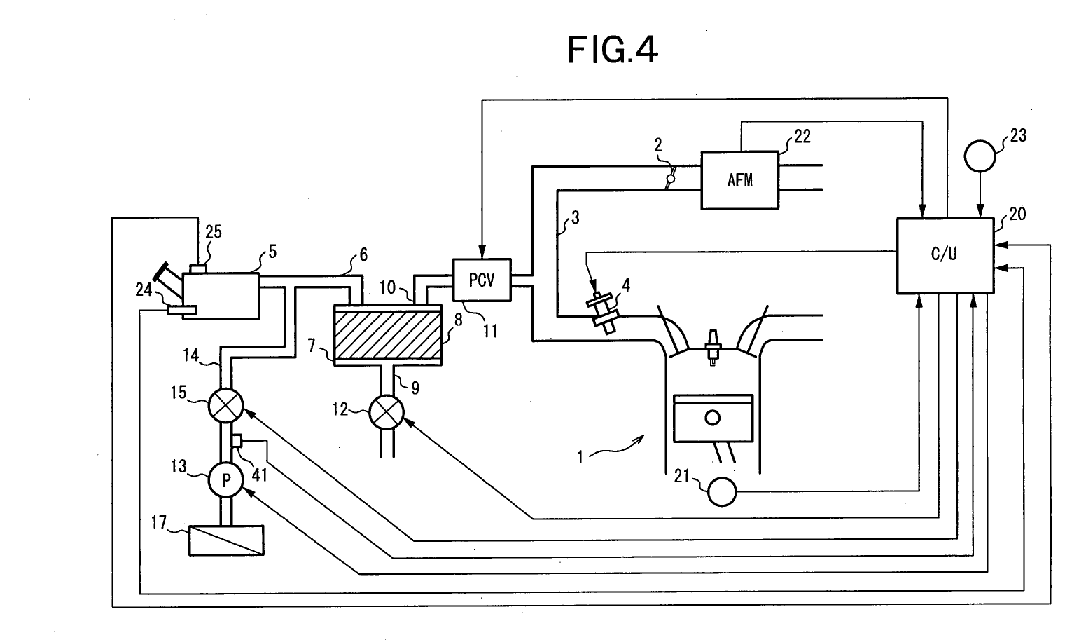

For judging the pressure state of the downstream of air pump 13, as shown in FIG. 4, a pressure sensor 41 is disposed for detecting a pressure between air pump 13 and electromagnetic check valve 15.

Otherwise, an electric current value indicating a load of air pump 13 is detected, to estimate the pressure between air pump 13 and electromagnetic check valve 15.

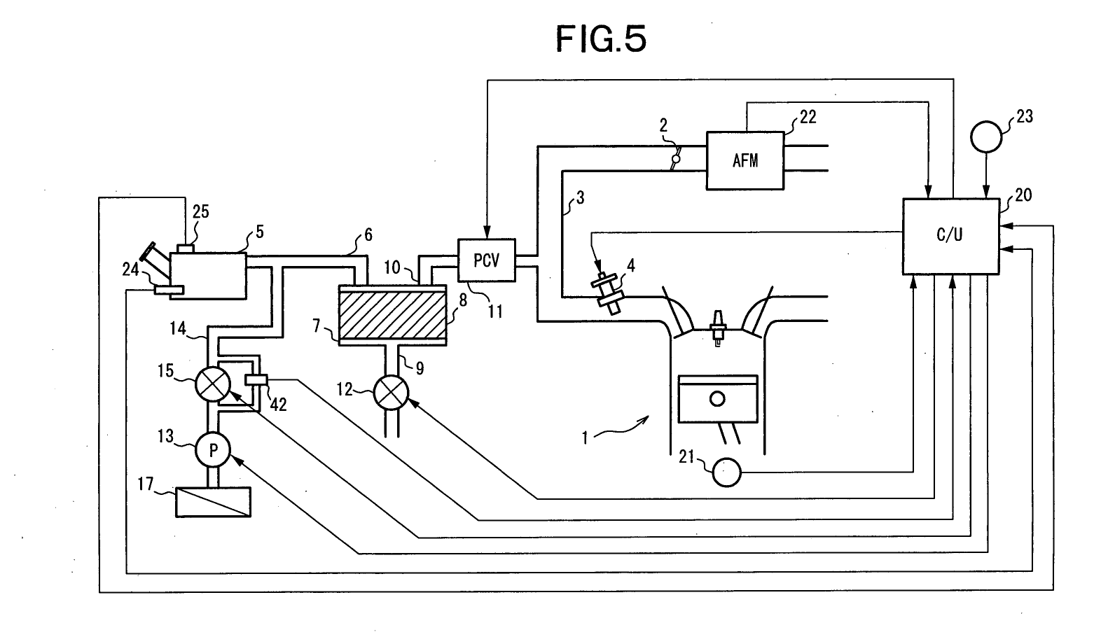

Or, as shown in FIG. 5, a differential pressure sensor 42 is disposed for detecting a differential pressure between the front and the back of electromagnetic check valve 15.

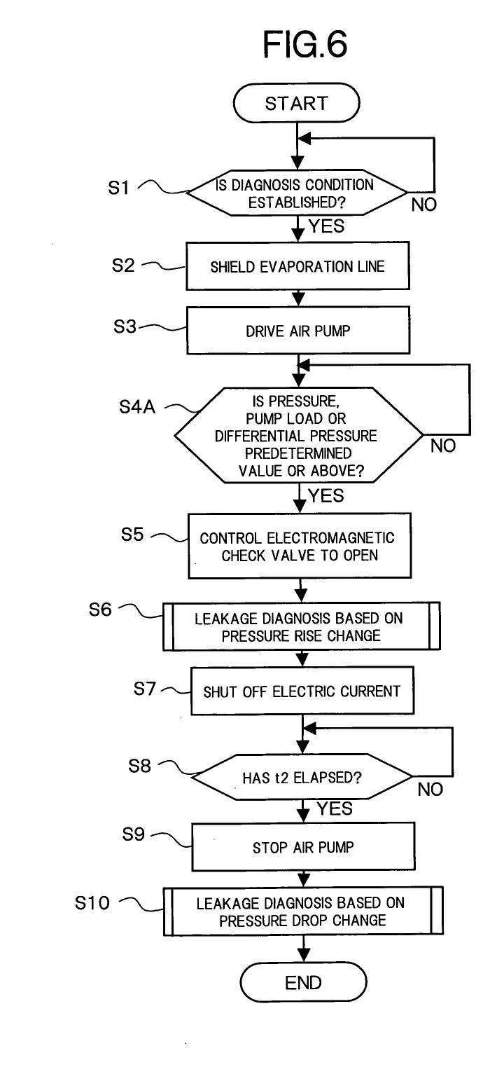

Then, as shown in step S4A of a flowchart in FIG. 6, at the time when a pressure detected by pressure sensor 41 reaches a predetermined pressure or above, at the time when an electric current value of pump (pump load) reaches a predetermined electric current value or above, or at the time when the differential pressure between the front and the back of electromagnetic check valve 15 reaches a predetermined pressure or above at which the occurrence of backflow can be avoided, electromagnetic check valve 15 is opened.

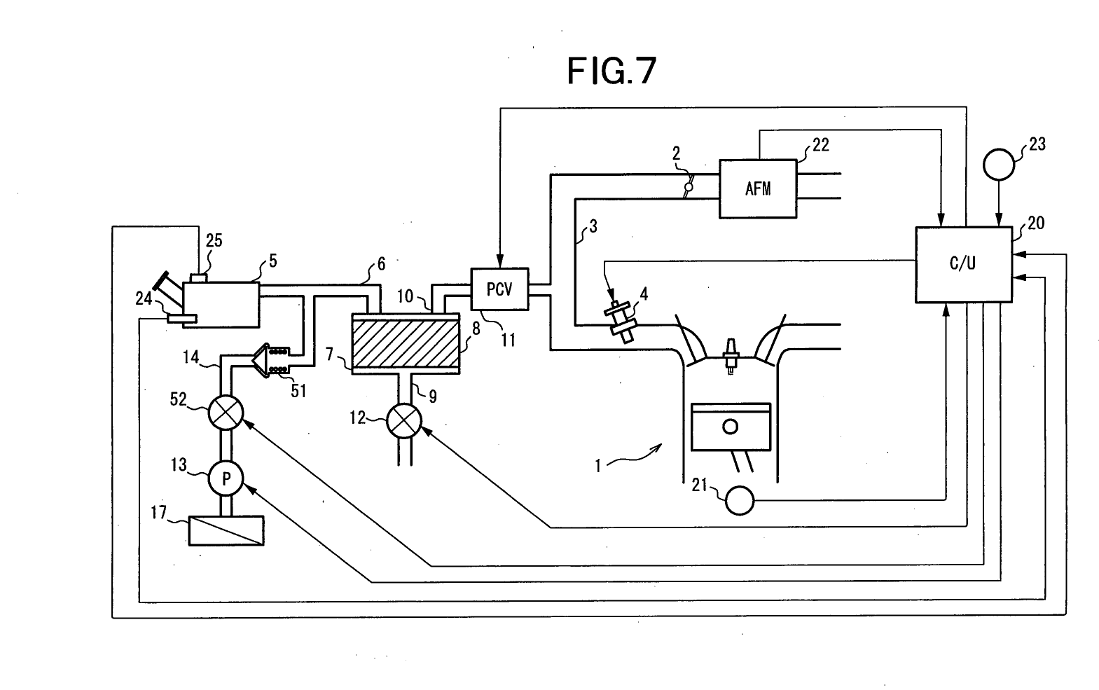

Further, as shown in FIG. 7, a mechanical check valve 51 and a closed type electromagnetic open/close valve 52 can be serially disposed in the halfway of air supply pipe 14.

Also in a system serially provided with mechanical check valve 51 and electromagnetic open/close valve 52 shown in FIG. 7, if electromagnetic open/close valve 52 is opened with a delay to the operation start of air pump 13, and is closed prior to the operation stop of air pump 13, it is possible to avoid the occurrence of backflow at the pressurization starting time and at the pressurization stopping time.

Moreover, in the system serially provided with mechanical check valve 51 and electromagnetic open/close valve 52 shown in FIG. 7, the configuration may be such that electromagnetic open/close valve 52 is opened immediately when air pump 13 starts to operate, and then, after the time when the differential pressure reaches the predetermined value or above and mechanical check valve 51 is opened, the air supply to the diagnosis section is started, whereas, when the operation of air pump 13 is stopped, electromagnetic open/close valve 52 is closed prior to the operation stop of air pump 13.

In the system serially provided with mechanical check valve 51 and electromagnetic open/close valve 52 shown in FIG. 7, since air supply pipe 14 can be kept to be in a shielded state by electromagnetic open/close valve 52, in the state where the operation of air pump 13 is stopped, an urging force for closing mechanical check valve 51 can be set to a minimum value at which the occurrence of backflow at the pressurization starting time can be avoided.

Consequently, in the system serially provided with mechanical check valve 51 and electromagnetic open/close valve 52 shown in FIG. 7, it is possible to start the pressurization with a good response characteristic while preventing the occurrence of backflow.

In the above embodiment, the configuration has been shown in which the diagnosis section is pressurized with the air supply by air pump 13. However, also in the case where the diagnosis section is depressurized with the air suction by the air pump, it is possible that a valve opening control is delayed to the operation start of air pump 13 and/or a valve closing control is performed prior to the operation stop of air pump 13, thereby preventing the occurrence of backflow.

Further, it is apparent that the structure of electromagnetic check valve 15 is not limited to that in FIG. 2, and the actuator is not limited to the electromagnetic solenoid, and another actuator can be used.

The entire contents of Japanese Patent Application No. 2003-317993 filed on Sep. 10, 2003, a priority of which is claimed, are incorporated herein by reference.

While only a selected embodiment has been chosen to illustrate the present invention, it will be apparent to those skilled in the art from this disclosure that various changes and modifications can be made herein without departing from the scope of the invention as defined in the appended claims.

Furthermore, the foregoing description of the embodiment according to the present invention is provided for illustration only, and not for the purpose of limiting the invention as defined in the appended claims and their equivalents.

1. An air transfer apparatus, comprising:
an air pump transferring air to a shielded section;
a valve disposed in a transfer passage through which the air is transferred by said air pump; and
a control unit that controls operation/stop of said air pump and open/close of said valve,
wherein said control unit;
sets a time lag between switching control timing of the operation/stop of said air pump, and open/close control timing of said valve.

2. An air transfer apparatus according to claim 1,
wherein said control unit;
opens said valve with a delay to the operation start of said air pump.

3. An air transfer apparatus according to claim 2,
wherein said control unit;
opens said valve after a previously set period of time has elapsed after the operation start of said air pump.

4. An air transfer apparatus according to claim 2, further comprising;
a pump load detector detecting a load of said air pump,
wherein said control unit;
opens said valve when the load of said air pump reaches a threshold after the operation start of said air pump.

5. An air transfer apparatus according to claim 2, further comprising;
a pressure detector detecting a pressure in said transfer passage between said air pump and said valve,
wherein said control unit;
opens said valve when the pressure in said transfer passage between said air pump and said valve reaches a threshold after the operation start of said air pump.

6. An air transfer apparatus according to claim 2, further comprising;
a differential pressure detector detecting a differential pressure between the front and the back of said air pump,
wherein said control unit;
opens said valve when the differential pressure of said air pump reaches a threshold after the operation start of said air pump.

7. An air transfer apparatus according to claim 1,
wherein said control unit;
closes said valve prior to the operation stop of said air pump.

8. An air transfer apparatus according to claim 7,
wherein said control unit;
stops said air pump after a previously set period of time has elapsed after said valve was closed.

9. An air transfer apparatus according to claim 1,
wherein said valve is a check valve provided with a resilient member urging a valve body for valve closing by a force at or above a maximum pressure generated by said air pump, and said check valve is further provided with an actuator generating a force for valve opening against the urging force for valve closing.

10. An air transfer apparatus according to claim 1,
wherein a check valve is disposed in the transfer passage through which the air is transferred by said air pump, and
said valve is an electromagnetic valve disposed serially to said check valve.

11. An air transfer apparatus according to claim 1,
wherein said shielded section is formed by shielding by means of said valve a predetermined section of a fuel vapor passage in a fuel vapor purge system of an internal combustion engine.

12. An air transfer apparatus, comprising:
air transfer means for transferring air to a shielded section;
switching means for opening/closing a transfer passage through which the air is transferred by said air transfer means; and
control means for controlling the operation/stop of said air transfer means and the switching operation of said switching means,
wherein said control means;
sets a time lag between switching control timing of the operation/stop of said air pump, and switching control timing of said switching means.

13. A control method of an air transfer apparatus which comprises an air pump transferring air to a shielded section and a valve disposed in a transfer passage through which the air is transferred by said air pump, comprising the steps of:
setting a time lag between switching control timing of operation/stop of said air pump, and open/close control timing of said valve; and
controlling the operation/stop of said air pump and the open/close of said valve based on said time lag.

14. A control method of an air transfer apparatus according to claim 13,
wherein said step of controlling the operation/stop of said air pump and the open/close of said valve;
controls said valve to open with a delay to an operation start control of said air pump.

15. A control method of an air transfer apparatus according to claim 14,
wherein said step of setting said time lag;
sets a fixed delay time between operation start control timing of said air pump and the open control timing of said valve.

16. A control method of an air transfer apparatus according to claim 14, further comprising the step of;
detecting a load of said air pump,
wherein said step of setting said time lag;
sets a period of time until the load of said air pump reaches a threshold after the operation start of said air pump, as said time lag.

17. A control method of an air transfer apparatus according to claim 14, further comprising the step of;
detecting a pressure in said transfer passage between said air pump and said valve,
wherein said control unit;
opens said step of setting said time lag;
sets a period of time until the pressure in said transfer passage between said air pump and said valve reaches a threshold after the operation start of said air pump, as said time lag.

18. A control method of an air transfer apparatus according to claim 14, further comprising the step of;
detecting a differential pressure between the front and the back of said air pump,
wherein said step of setting said time lag;
sets a period of time until the differential pressure of said air pump reaches a threshold after the operation start of said air pump, as said time lag.

19. A control method of an air transfer apparatus according to claim 13,
wherein said step of controlling the operation/stop of said air pump and the open/close of said valve;
controls said valve to close prior to an operation stop control of said air pump.

20. A control method of an air transfer apparatus according to claim 19,
wherein said step of said time lag;
sets a fixed delay time between the close control timing of said valve and stop control timing of said air pump.
